(19) United States
(12) Patent Application Publication
(10) Pub. No.: US 2020/0370585 A1
(43) Pub. Date: Nov. 26, 2020

(54) HIDDEN CONNECTOR AND CONNECTION SYSTEM

(71) Applicant: Xiang Huang, Doral, FL (US)

(72) Inventor: Xiang Huang, Doral, FL (US)

(21) Appl. No.: 16/420,538

(22) Filed: May 23, 2019

(51) Int. Cl. F16B 12/36; A47B 96/20

(52) U.S. Cl. CPC F16B 12/36; A47B 96/201

(57) ABSTRACT

A connector for connecting a first part to a second part, the connector including a tongue element with substantially parallel first and second surfaces, with a perimeter of the tongue element increasing from the first surface to the wider second surface. The connector includes at least one cylindrical element extending out from the first surface in a substantially perpendicular direction. The first part includes a groove and the second part includes at least one hole. Each cylindrical element of the connector is pressed into a respective hole of the second part to form a friction fit connection and the tongue element of the connector is inserted into the groove of the first part at a wider opening of the groove and then slid along the groove towards a more narrow opening so that the tongue element becomes wedged into an end of the groove at the more narrow opening.

### TECHNICAL FIELD

This disclosure relates to connection systems for joining structural components and, more specifically, for tool-less connection systems used in the assembly and disassembly of furniture.

### BACKGROUND

There are many ways to connect structural components (e.g., parts of a piece of furniture) to each other, such as: tongue and groove joints, mortise and tenon joints and sliding dovetail joints, all of which may provide strong and secure joints. However, all of these known ways require the use of tools of some sort (e.g., screws, nails, bolts, glue), and many result in visible connectors at the joints. When the connectors are visible after assembly of the structural components (e.g., pieces of a furniture), aesthetic appearance of the assembled structure may be negatively affected by unattractive connectors.

Commercialization of ready to assemble (“RTA”) furniture and many other RTA wood and plastic products may be hindered by a connection system that requires tools in order to assemble an RTA product. The need for tools complicates the assembly process and may prolong the time needed by a consumer to complete the assembly. For example, a “bag” of hardware elements (e.g., including connectors and tools) may need to be inspected by the consumer and then used to assemble the product.

### BRIEF DESCRIPTION OF THE DRAWINGS

The present disclosure is illustrated by way of example, and not by way of limitation, in the figures of the accompanying drawings.

FIG. 1 is a perspective view of a connector for connecting a first part to a second part, according to some implementations of the present disclosure.

FIG. 2A is a top view of a groove in the first part, according to some implementations of the present disclosure.

FIG. 2B is a top view of holes in the second part, according to some implementations of the present disclosure.

FIG. 3 is a flow diagram illustrating a method for connecting a first part to a second part with a connector, according to some implementations of the present disclosure.

FIG. 4 is a flow diagram illustrating a method for inserting a tongue element of the connector into a groove in the first part, according to some implementations of the present disclosure.

FIG. 5 is a perspective view of the tongue element of the connector being inserted into a wider opening of the groove in the first part, according to some implementations of the present disclosure.

FIG. 6 is a perspective view of the tongue element being slid along the groove away from the wider opening in order to wedge the tongue element into a narrower opening of the groove, according to implementations of the present disclosure.

### DETAILED DESCRIPTION

It is understood that the present disclosure is intended to be illustrative, and not restrictive, in regard to any features, advantages and embodiments of the hidden connector, connection system and connection method described herein.

Embodiments of the hidden connection system described herein may include 3 or more system elements. A first system element may include a router cut (e.g., a groove or slot) into one side of a first of the “to be connected” parts (e.g., parts of a piece of furniture). A second system element may include at least one hole drilled into one side of a second of the “to be connected” parts. A third system element may include a one-piece connector (e.g., molded from plastic, metal, or wood) that includes two connection elements. A first connection element of the connector may include a tongue element (e.g., a ridge) configured to be inserted into the groove of the first of the “to be connected” parts. A second connection element of the connector may include at least one cylindrical element (e.g., a pin or post) configured to be pushed into respective ones of the at least one hole of the second of the “to be connected” parts. Once the cylindrical elements of the connector are securely in place in the holes of the second part, the tongue element of the connector may be inserted into the groove of the first part and then wedged into an end of the groove, forming a secure connection that is also hidden by the mass of the first and second of the “to be connected” parts.

Furthermore, the connected first and second parts may also be easily separated from each other by simply reversing the connection steps so that both connecting and separating the first and second parts is fast and straightforward.

Embodiments of the connector described herein may be made from a plastic or metal or wood or composite material. For example, aluminum or steel may be utilized for a sheet metal type design. Metals may be used (instead of plastic) for the connectors when more shear strength is needed for connecting a particular structure or when structures may be used in high temperature conditions so that the connectors do not melt and/or deform. Of course, any suitable materials may be used for the connector if they possess sufficient mechanical qualities for strength and flexibility. The RTA structures/objects for which the connectors may be used may include any: furniture, panels, substrates, hardware or other construction components or combinations thereof.

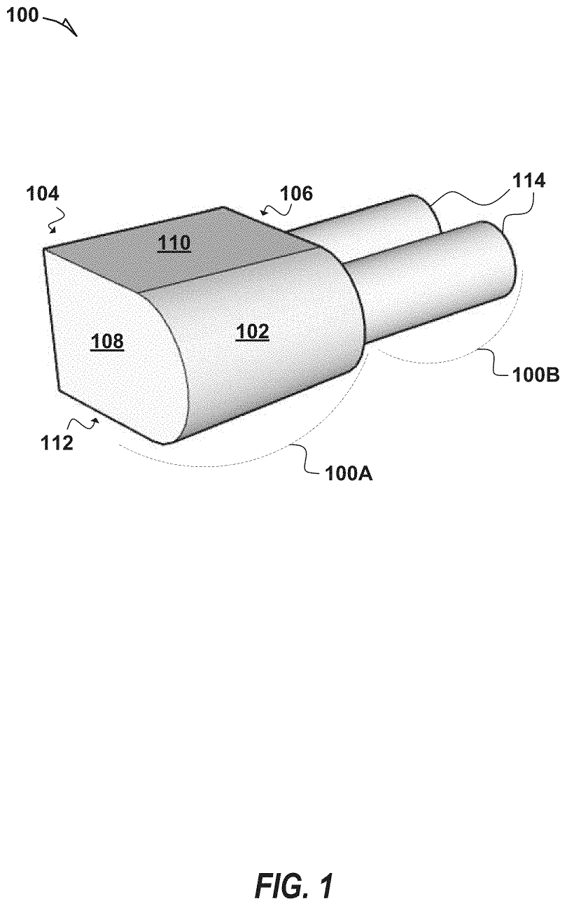

FIG. 1 is a perspective view of a connector 100 for connecting a first part to a second part, according to some implementations of the present disclosure.

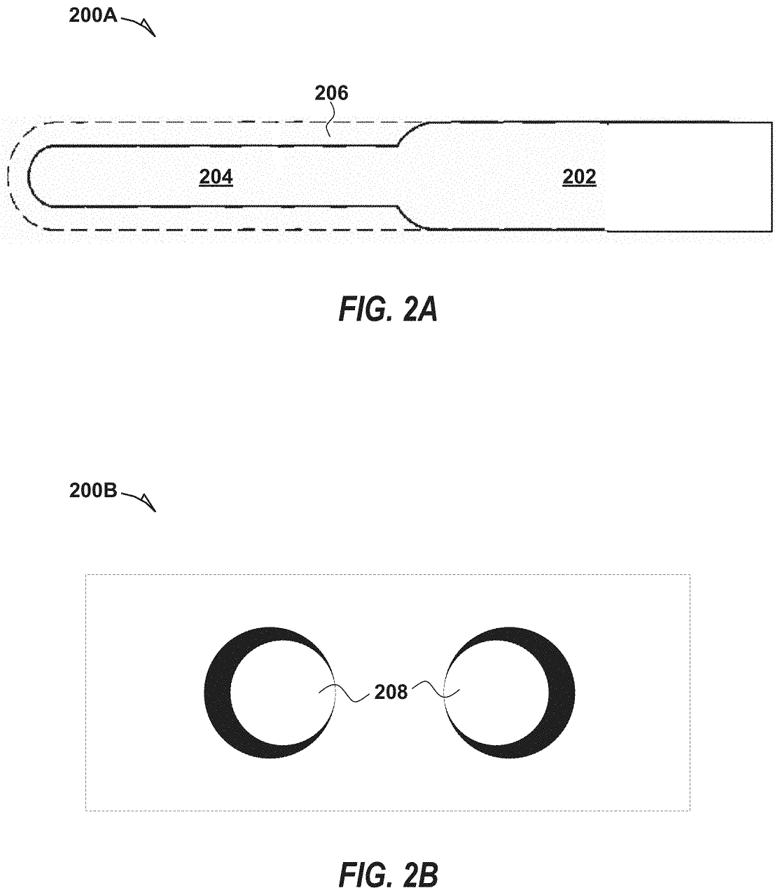

The connector 100 for connecting a first part to a second part, may include a first connection element 100A including a first end enclosed by a first surface 102 that is substantially rounded and a second end opposite to the first end and enclosed by a second surface 104. The first connection element 100A may also include a third surface 106 and a fourth surface 108 substantially parallel to the third surface 106. The third surface 106 may be connected to a first edge of the first surface 102 and a first edge of the second surface 104, and the fourth surface 108 may be connected to a second edge of the first surface 102 and a second edge of the second surface 104. The first connection element 100A may also include a fifth surface 110 connecting a third edge of the first surface 102 to a third edge of the second surface 104 and a sixth surface 112 connecting a fourth edge of the first surface 102 to a fourth edge of the second surface 104. A width of the third surface 106 measured as a surface distance on the third surface 106 from the fifth surface 110 to the sixth surface 112 is smaller than a surface width of the fourth surface 108 measured as a distance on the fourth surface 108 from the fifth surface 110 to the sixth surface 112. The first connection element 100A may include the male side of a connection (e.g., a tongue) with the female side (e.g., a groove) being cut into the first part to be connected, as explained below with respect to FIG. 2A.

The connector 100 for connecting a first part to a second part, may include a second connection element 100B including at least one (e.g., 1, 2, 3 . . . ) cylindrical element 114 (e.g., a pin or shaft) connected to the third surface 106, wherein an axis of each of the at least one cylindrical element 114 is substantially perpendicular to the third surface 106. The second connection element 100B may include the male side of a connection (e.g., at least one pin or shaft) with the female side (e.g., at least one corresponding hole) being cut into the second part to be connected, as explained below with respect to FIG. 2B. In one implementation as shown in FIG. 1, the at least one cylindrical element 114 may include two cylindrical elements that, compared to only one cylindrical element, may provide structurally more stable connection to the second part.

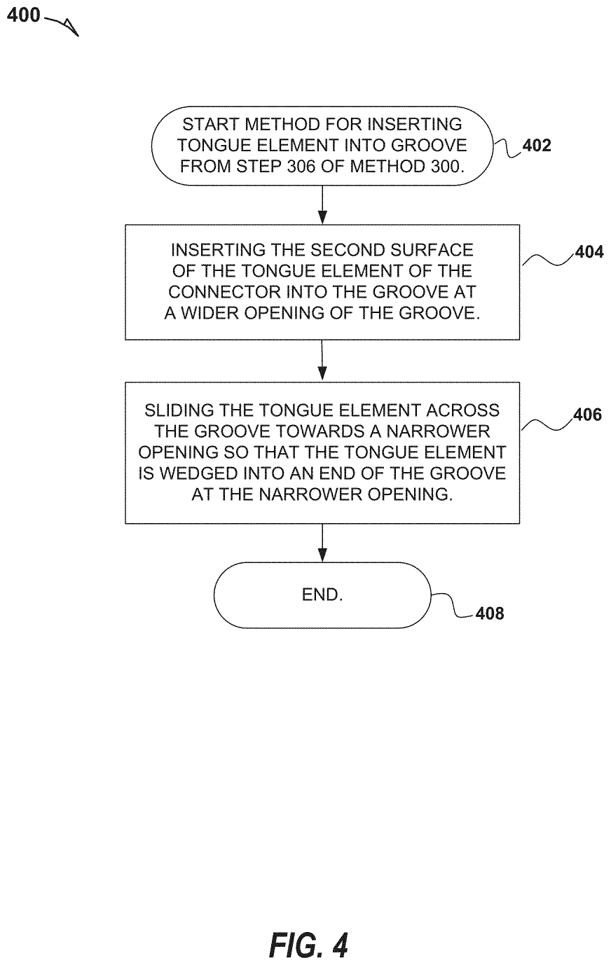

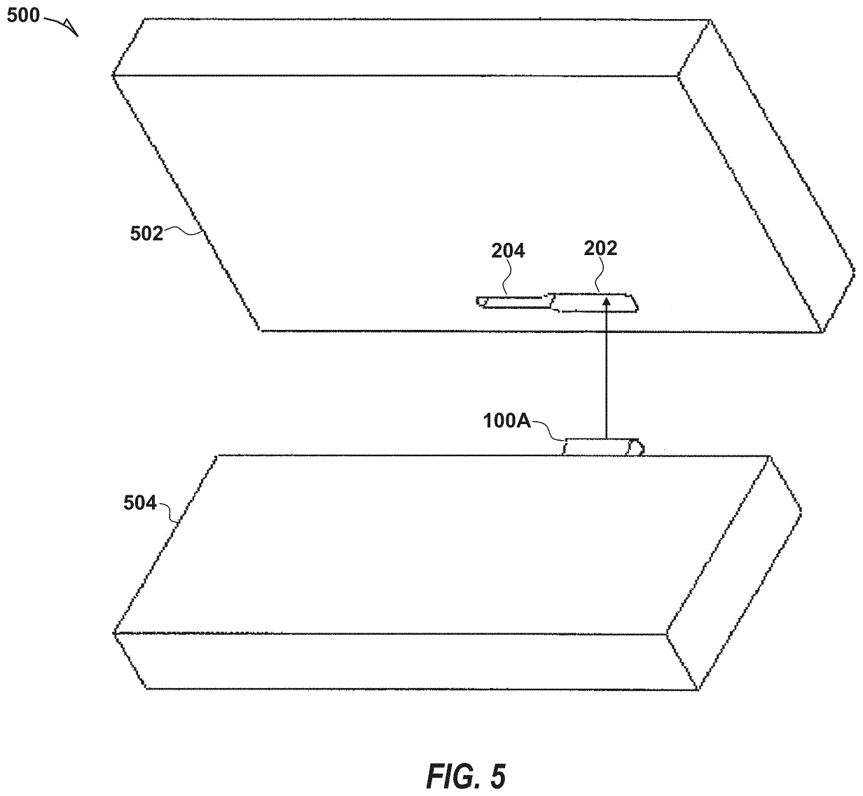

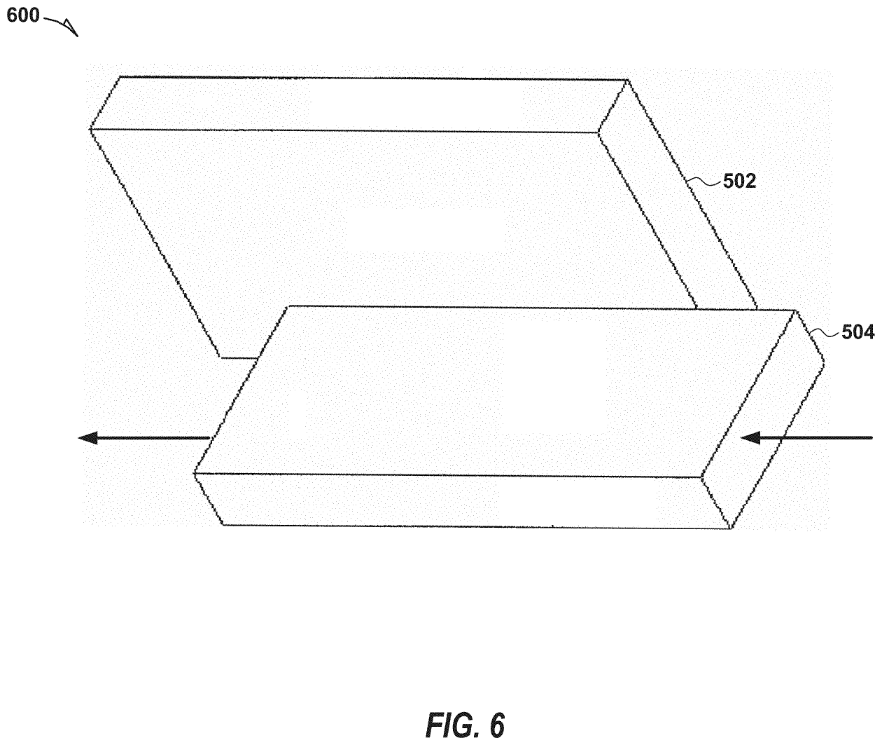

Once the second connection element 100B is secured (friction fit connection) into place within the holes in the second part, the connector 100 and the second part may become one “element” for connection to the first part as explained below with respect to FIGS. 4 and 5. Once the connector 100 and the second part are connected, the first connection element 100A may be inserted into a groove in the first part and slid along the groove so as to become wedged in the groove, as explained below with respect to FIGS. 5 and 6. Once the first connection element 100A is inserted and slid into place in the groove, a secure hidden connection between the first part and the second part may be formed with the connector 100 in between the first and second parts.

As noted above, the connector 100 may include a first connection element 100A including a male side of a connection (e.g., a tongue). The first connection element 100A may have a perimeter (e.g., measured around the first surface 102, the fifth surface 110, the second surface 104 and the sixth surface 112) that increases as it progresses from the third surface 106 to the wider fourth surface 108. Therefore, the first connection element 100A may have a trapezoidal shape that flares outward progressively from the narrower third surface 106 to the wider fourth surface 108.

FIG. 2A is a top view of a groove 200A in the first part, according to some implementations of the present disclosure.

As noted above, the connector 100 for connecting a first part to a second part, may include first connection element 100A in the form of a tongue to act as the male side of a connection with the first part. Also noted above, the female side of the connection may include a groove 200A cut into the first part. In some embodiments, the groove 200A may be configured to receive the first connection element 100A (e.g., a tongue) and form a tongue and groove type connection based on the complimentary shapes of the first connection element 100A and the groove 200A as explained below.

In some embodiments, the groove 200A may include a wider opening 202 at a first end of the groove 200A and a narrower opening 204 at the opposite end of the groove. Furthermore, the groove 200A may have a uniform width from the wider opening 202 to a bottom of the groove 200A and the groove 200A may have an increasing width from the narrower opening 204 to the bottom of the groove 200A. As noted above, the first connection element 100A and the groove 200A may have complimentary shapes, so that the increasing width of the groove 200A from the narrower opening 204 to the bottom of the groove 200A may correspond to the increasing perimeter of the first connection element 100A from the narrower third surface 106 of connector 100 to the wider fourth surface 108 of the connector 100. This complimentary relationship between the shapes of the first connection element 100A and the groove 200A may allow the first connection element 100A to be received at the wider opening 202 of groove 200A and then slid across the groove 200A towards the narrower end 204 in order to from a secure connection by becoming wedged into the end of the groove 200A at the narrower end 204 as explained below.

In some embodiments, the narrower opening 204 of the groove 200A may have a substantially equal width at the bottom of the groove 200A as the uniform width of the groove 200A at the wider opening 202. As noted above, the groove 200A may have an increasing width from the narrower opening 204 to the bottom of the groove 200A. The portion 206 of the groove 200A includes the portion of the groove 200A with the increasing width. The width of portion 206 of the groove 200A increases from the width of the narrower opening 204 to the width at the bottom of the groove 200A (which is uniform throughout the groove) and denoted by the dotted lines of portion 206.

In some embodiments, the third surface 106 of connector 100 is narrower than the narrower opening 204 of groove 200A, and the fourth surface 108 of connector 100 is wider than the narrower opening 204 of groove 200A and narrower than the wider opening 202 of groove 200A. Therefore, because the fourth surface 108 of connector 100 is wider than the narrower opening 204, the first connection element 100A may only be received by the groove 200A at the wider opening 202 before being slid across the groove 200A towards the narrower opening 204 in order to become wedged into the groove 200A at an end of the grove 200A at the narrower opening 204.

FIG. 2B is a top view of holes 200B in the second part, according to some implementations of the present disclosure.

In some embodiments, the second part includes at least one hole 200B that is configured to form a friction fit connection with the at least one cylindrical element 114 of the second connection element 100B. A friction fit connection is a connection between two parts which is achieved by friction between the parts after the parts have been pushed together (e.g., one part inserted into an opening in the other part), rather than by any other means of connection. Alternatively, the at least one cylindrical element 114 may be engaged to the at least one hole 200B using a glue (e.g., a wood glue) or using any suitable means that securely connects the at least one cylindrical element 114 of the second connection element 100B to the at least one hole 200B. Therefore, the at least one cylindrical element 114 of the second connection element 100B may be inserted into the at least one hole 200B of the second part to form a shaft and hole type connection based on the shapes 208 of the at least one hole 200B of the second part which are configured to be complimentary to the shape of the at least one cylindrical element 114 of the second connection element 100B.

In some embodiments, the edges of the at least one cylindrical element 114 of the second connection element 100B and the edges of the at least one hole 200B of the second part may be chamfered (beveled). The chamfered edges may serve to guide the insertion of the at least one cylindrical element 114 into the at least one hole 200B, helping to distribute the insertion force evenly around the circumference of the at least one hole 200B. Distribution of the insertion force may allow any compression (e.g., of the at least one cylindrical element 114) to occur gradually instead of all at once, thus making the insertion smoother, more easily controlled, and less reliant on a large insertion force (based on less force needed at any one instant of time). The chamfered edges may also serve to align the at least one cylindrical element 114 of the second connection element 100B so that it is parallel with the at least one hole 200B of the second part that it is being inserted into.

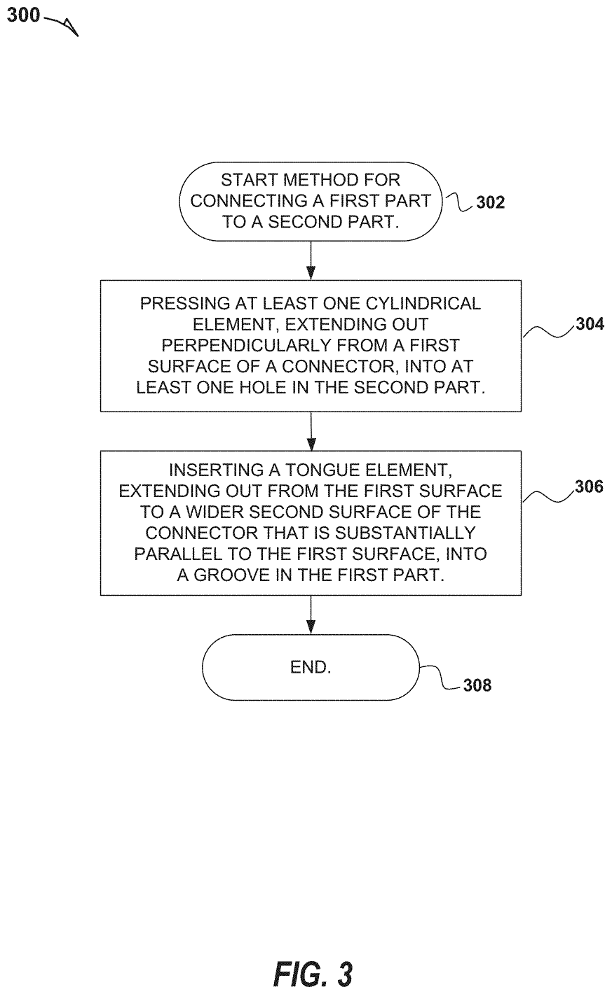

FIG. 3 is a flow diagram illustrating a method 300 for connecting a first part to a second part with a connector 100, according to some implementations of the present disclosure.

Referring to FIG. 3, at 302, the method 300 for connecting a first part to a second part may be commenced. For example, the first and second parts to be connected may be gathered together with a connector 100 for connecting the parts.

At 304, at least one cylindrical element 114, extending out perpendicularly from a first surface (e.g., third surface 106 of FIG. 1) of a connector 100, is pressed into at least one hole 200B in the second part. As noted above, the shapes 208 of the at least one hole 200B of the second part are configured to be complimentary to the shape of the at least one cylindrical element 114 of the second connection element 100B. Therefore, the at least one cylindrical element 114 may form a secure friction fit connection with the at least one hole 200B in the second part based on the at least one cylindrical element 114 being pressed into the tight-fitting at least one hole 200B in the second part.

At 306, a tongue element (e.g., first connection element 100A of FIG. 1), extending out from the first surface (e.g., third surface 106 of FIG. 1) to a wider second surface (e.g., third surface 106 of FIG. 1) of the connector 100 that is substantially parallel to the first surface (e.g., third surface 106 of FIG. 1), is inserted into a groove 200A in the first part. As noted above, the groove 200A may be configured to receive the first connection element 100A (e.g., the tongue element) and form a tongue and groove type connection based on the complimentary shapes of the first connection element 100A and the groove 200A. For example, a perimeter of the tongue element (e.g., 100A of FIG. 1) may increase from the narrower first surface (e.g., third surface 106 of FIG. 1) to the wider second surface (e.g., fourth surface 108 of FIG. 1). Furthermore, the groove 200A may include a wider opening 202 and a narrower opening 204 with the groove 200A having a uniform width from the wider opening 202 to a bottom of the groove 200A and an increasing width from the narrower opening 204 to the bottom of the groove 200A. Therefore, the increasing width of groove 200A at the narrower opening 204 may correspond to the increasing perimeter of the tongue element (e.g., 100A of FIG. 1) so that the shapes of tongue element (e.g., 100A of FIG. 1) and groove 200A are complimentary to each other.

In some embodiments, the groove 200A at the narrower opening 204 may have a substantially equal width at the bottom of the groove 200A as the uniform width of the groove 200A at the wider opening 202. Furthermore, the first surface (e.g., third surface 106 of connector 100 of FIG. 1) may be narrower than the narrower opening 204, and the second surface (e.g., fourth surface 108 of FIG. 1) may be wider than the narrower opening 204 and narrower than the wider opening 202. Therefore, the tongue element (e.g., 100A of FIG. 1) of connector 100 may be received by the groove 200A at the wider opening 202 since the wider second surface (e.g., fourth surface 108 of FIG. 1) tongue element (e.g., 100A of FIG. 1) may not pass through the narrower opening 202.

At 308, the method for connecting the first part to the second part may be concluded. For example, the connected first and second parts may be connected to further parts (e.g., of a piece of furniture to be assembled) or if no further parts are to be connected then the connected first and second parts (e.g., assembled piece of furniture) may be set up in the environment in which they are to be used.

FIG. 4 is a flow diagram illustrating a method 400 for inserting a tongue element (e.g., first connection element 100A of FIG. 1) of the connector 100 into a groove 200A in the first part, according to implementations of the present disclosure.

Referring to FIG. 4, at 402, the method 400 for inserting a tongue element (e.g., first connection element 102 of FIG. 1) of the connector 100 into a groove 200A in the second part may be commenced from 306 of method 300 of FIG. 3. For example, the method 400 may determine whether the second part and the connector 100 have been “paired” to form a single element by inserting the at least one cylindrical element 114 of the second connection element 100B of connector 100 into the at least one hole 200B of the second part to from a secure friction fit connection.

At 404, the second surface (e.g., fourth surface 108 of FIG. 1) of the tongue element (e.g., 100A of FIG. 1) of connector 100 may be inserted into the groove 200A at the wider opening 202. As noted above, the second surface (e.g., fourth surface 108 of FIG. 1) is wider than the narrower opening 204 of groove 200A and narrower than the wider opening 204 of groove 200A. Therefore the second surface (e.g., fourth surface 108 of FIG. 1) may be received by the groove 200A at the wider opening 202 of the groove 200A as shown in FIG. 5. In an embodiment, the second surface (e.g., fourth surface 108 of FIG. 1) of the tongue element (e.g., 100A of FIG. 1) may be inserted into the groove 200A at the wider opening 202 with a first end of connector 100 (e.g., enclosed by first surface 102 of FIG. 1) that is substantially rounded pointed towards the end of the groove 200A with the narrower opening 202. The rounded first end may help the tongue element (e.g., 100A of FIG. 1) slide along the groove 200A towards the narrower end 204 of the groove 200A without binding or catching the tongue element (e.g., 100A of FIG. 1) along the sides of the groove 200A.

At 406, the tongue element (e.g., 100A of FIG. 1) may be slid along the groove 200A towards the narrower opening 204 so that the tongue element is wedged into an end of the groove 200A at the narrower opening 204. As noted above, an increasing width of groove 200A at the narrower opening 204 may correspond to an increasing perimeter of the tongue element (e.g., 100A of FIG. 1) so that the shapes of tongue element (e.g., 100A of FIG. 1) and groove 200A are complimentary to each other. Therefore, the tongue element (e.g., 100A of FIG. 1) may slide along the groove 200A from the wider opening 202, into which it was inserted, towards the narrower opening 204 at the other end of the groove 200A. The second surface (e.g., fourth surface 108 of FIG. 1) of the tongue element (e.g., 100A of FIG. 1) may then become wedged into the wider bottom of the groove 200A at the narrower opening 204, as shown in FIG. 6.

At 408, the method for inserting a tongue element (e.g., 100A of FIG. 1) of the connector 100 into a groove 200A in the first part may be concluded. As noted above, the connected first and second parts may be connected to further parts (e.g., of a piece of furniture to be assembled) or if no further parts are to be connected then the connected first and second parts (e.g., assembled piece of furniture) may be set up in the environment in which they are to be used.

FIG. 5 is a perspective view 500 of the tongue element (e.g., first connection element 100A of FIG. 1) of the connector 100 (already connected to second part 504) being inserted into a wider opening 202 of the groove 200A in the first part 502, according to some implementations of the present disclosure.

As noted above, the second part 504 and the connector 100 have been “paired” to form a single element by inserting (e.g., as indicated by the arrow) the at least one cylindrical element 114 of the second connection element 100B of the connector 100 into the at least one hole 200B of the second part 504 to from a secure friction fit connection. Also noted above, the second surface (e.g., fourth surface 108 of FIG. 1) of the tongue element 100A of the connector 100 is wider than the narrower opening 204 of groove 200A in the first part 502 and narrower than the wider opening 204 of groove 200A. Therefore the second surface (e.g., fourth surface 108 of FIG. 1) of the tongue element 100A may be received by the groove 200A at the wider opening 202 of the groove 200A as shown.

FIG. 6 is a perspective view 600 of the tongue element (e.g., first connection element 100A) being slid along the groove 200A (in the first part 502) away from the wider opening 202 in order to wedge the tongue element 100A into a narrower opening 204 of the groove 200A, according to implementations of the present disclosure.

As noted above, an increasing width of groove 200A at the narrower opening 204 may correspond to an increasing perimeter of the tongue element 100A so that the shapes of the tongue element 100A and the groove 200A in first part 502 are complimentary to each other. Therefore, the tongue element 100A (e.g., together with the “paired” second part 504) may slide (e.g., as indicated by arrows) along the groove 200A from the wider opening 202, into which the tongue element 100A was inserted, towards the narrower opening 204 at the other end of the groove 200A. The second surface (e.g., fourth surface 108 of FIG. 1) of the tongue element 100A may then become wedged into the wider bottom of the groove 200A at the narrower opening 204.

Language:

In the foregoing descriptions, numerous details are set forth. It will be apparent, however, to one of ordinary skill in the art having the benefit of this disclosure, that the present disclosure may be practiced without all of these specific details. In some instances, well-known structures and devices are shown in block diagram form, rather than in detail, in order to avoid obscuring the present disclosure.

The words “example” or “exemplary” are used herein to mean serving as an example, instance, or illustration. Any aspect or design described herein as “example’ or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such.

Reference throughout this specification to “one implementation” or “an implementation” means that a particular feature, structure, or characteristic described in connection with the implementation is included in at least one implementation. Thus, the appearances of the phrase “in one implementation” or “in an implementation” in various places throughout this specification are not necessarily all referring to the same implementation. In addition, the term “or” is intended to mean an inclusive “or” rather than an exclusive “or.”

It is to be understood that the above description is intended to be illustrative, and not restrictive. Many other implementations will be apparent to those of skill in the art upon reading and understanding the above description. The scope of the disclosure should, therefore, be determined with reference to the appended claims, along with the full scope of equivalents to which such claims are entitled.

1. A connector for connecting a first part to a second part, the connector comprising:
a tongue element extending from a narrower first surface to a wider second surface that is substantially parallel to the first surface; and
at least one cylindrical element integrally connected to the first surface, wherein an axis of the at least one cylindrical element is substantially perpendicular to the first surface.

2. The connector of claim 1, wherein a perimeter of the tongue element increases from the narrower first surface to the wider second surface.

3. The connector of claim 1, wherein the at least one cylindrical element comprises at least two spaced apart cylindrical elements.

4. The connector of claim 1, wherein the connector is molded from one of metal, plastic, or wood.

5. The connector of claim 1, wherein the first part and second part are parts of a piece of furniture.

6. A connection system comprising the connector of claim 1, wherein the first part comprises a groove to receive the tongue element, and the second part comprises at least one hole to receive the at least one cylindrical element.

7. The system of claim 6, further comprising a wider opening and a narrower opening of the groove, wherein the groove has a uniform width from the wider opening to a bottom of the groove and the groove has an increasing width from the narrower opening to the bottom of the groove.

8. The system of claim 7, wherein the groove at the narrower opening has a substantially equal width at the bottom of the groove as the uniform width of the groove at the wider opening.

9. The system of claim 8, wherein the first surface is narrower than the narrower opening, and the second surface is wider than the narrower opening and narrower than the wider opening.

10. The system of claim 9, wherein the at least one hole is configured to form a friction fit connection with the at least one cylindrical element.

11. A method for connecting a first part to a second part, the method comprising:
pressing at least one cylindrical element, extending out perpendicularly from a first surface of a connector, into at least one hole in the second part; and
inserting a tongue element, extending out from the first surface to a wider second surface of the connector that is substantially parallel to the first surface, into a groove in the first part.

12. The method of claim 11, wherein the at least one hole is configured to form a friction fit connection with the at least one cylindrical element based on the pressing.

13. The method of claim 11, wherein a perimeter of the tongue element increases from the narrower first surface to the wider second surface.

14. The method of claim 12, wherein the groove comprises a wider opening and a narrower opening, the groove has a uniform width from the wider opening to a bottom of the groove and the groove has an increasing width from the narrower opening to the bottom of the groove.

15. The method of claim 13, wherein the groove at the narrower opening has a substantially equal width at the bottom of the groove as the uniform width of the groove at the wider opening.

16. The method of claim 14, wherein the first surface is narrower than the narrower opening, and the second surface is wider than the narrower opening and narrower than the wider opening.

17. The method of claim 15, further comprising:
inserting the second surface of the connector into the groove at the wider opening; and
sliding the tongue element along the groove towards the narrower opening so that the tongue element is wedged into an end of the groove at the narrower opening.

18. A connector for connecting a first part to a second part, the connector comprising:
a first connection element comprising:
a first end enclosed by a first surface that is substantially rounded;
a second end opposite to the first end and enclosed by a second surface;
a third surface and a fourth surface that is wider than the third surface and substantially parallel to the third surface, wherein the third surface is connected to a first edge of the first surface and a first edge of the second surface, and the fourth surface is connected to a second edge of the first surface and a second edge of the second surface;
a fifth surface connecting a third edge of the first surface to a third edge of the second surface; and
a sixth surface connecting a fourth edge of the first surface to a fourth edge of the second surface; and
a second connection element comprising:
at least one cylindrical element connected to the third surface, wherein an axis of the at least one cylindrical element is substantially perpendicular to the third surface.

19. The connector of claim 18, wherein a perimeter of the first connection element increases from the third surface to the wider fourth surface.

20. The connector of claim 18, wherein the at least one cylindrical element comprises at least two spaced apart cylindrical elements.
